(19) United States
(12) Patent Application Publication
(10) Pub. No.: US 2015/0258564 A1
(43) Pub. Date: Sep. 17, 2015

(54) Apparatus for Protecting a Surface

(71) Applicant: Clifton Toulson, JR., Upper Marlboro, MD (US)

(72) Inventor: Clifton Toulson, JR., Upper Marlboro, MD (US)

(73) Assignee: Toulson Enterprises LLC, Upper Marlboro, MD (US)

(21) Appl. No.: 14/644,088

(22) Filed: Mar. 10, 2015

Related U.S. Application Data
(63) Continuation-in-part of application No. 61/951,384, filed on Mar. 11, 2014.

(51) Int. Cl. B05B 15/04; B32B 3/28; B32B 3/04; B32B 3/30; B32B 3/26; B05B 1/00; B32B 25/00

(52) U.S. Cl. CPC B05B 15/0487; B05B 1/00; B32B 3/28; B32B 25/00; B32B 3/30; B32B 3/266; B32B 3/04; B32B 2307/7265; B32B 2571/00; B32B 2439/00

(57) ABSTRACT

Disclosed is an apparatus for protecting a surface including a substrate configured to receive fluid and a layer disposed on the substrate configured to pass fluid thereto. The substrate has a leading edge with a recess that complements a portion of a tire footprint; defines a semicircle, defines a U-shape; or combinations thereof.

### REFERENCE TO EARLIER APPLICATION

This Application incorporates by reference and, under 35 U.S.C. §119(e), claims priority to US Provisional Patent Application Ser. No. 61/951,384 filed on Mar. 11, 2014.

### STATEMENT REGARDING FEDERALLY SPONSORED RESEARCH OR DEVELOPMENT

This invention is not the subject of federally sponsored research or development.

### RESERVATION OF COPYRIGHTS

Portions of the disclosure of this document contain material that is subject to copyright protection. The copyright owner has no objection to any reproduction of the document or disclosure as it appears in official records, but reserves all remaining rights under copyright.

### BACKGROUND OF THE INVENTION

Automobile care, specifically respecting wheels and tires, can involve applying solutions ranging from neutral liquid water through corrosive atomized cleaners, polishes and preservatives. Particularly with the latter and oil-based products, unavoidable over spray and run off can discolor and degrade the work area, typically a garage or drive way. Cleaning the unsightly damage can be costly.

What is needed and not taught or suggested in the art is an apparatus for protecting a work area or surface that is easy to position about a wheel or tire and capture over-sprayed and runoff fluids employed in wheel care.

The invention provides improved elements and arrangements thereof, for the purposes described, which are inexpensive, dependable and effective in accomplishing intended purposes of the invention.

Other features and advantages of the invention will become apparent from the following description of the preferred embodiment, which refers to the accompanying drawing.

### BRIEF DESCRIPTION OF THE DRAWING

The invention is described in detail below with reference to the following figures, throughout which similar reference characters denote corresponding features consistently, wherein:

FIG. 1 is a plan view of an embodiment of an apparatus for protecting a surface configured according to principles of the invention;

FIG. 2 is a bottom view of the embodiment of FIG. 1;

FIG. 3 is a cross-sectional detail view, drawn along line III-III in FIG. 1;

FIG. 4 is a cross-sectional detail view, drawn along line IV-IV in FIG. 2; and

FIG. 5 is an environmental perspective view of the embodiment of FIG. 1 positioned relative to a wheel.

### DETAILED DESCRIPTION OF THE PREFERRED EMBODIMENT

This disclosure is not limited in application to the details of construction and the arrangement of components set forth or illustrated in the drawings herein. The disclosure is capable of other embodiments and of being practiced or of being carried out in various ways. Phraseology and terminology used herein is for description and should not be regarded as limiting. Uses of “including,” “comprising” or “having” and variations thereof herein are meant to encompass the items listed thereafter and equivalents thereof as well as additional items. Unless limited otherwise, “connected,” “coupled” and “mounted,” and variations thereof herein are used broadly and encompass direct and indirect connections, couplings, and mountings. “Connected” and “coupled” and variations thereof are not restricted to physical or mechanical or electrical connections or couplings. Furthermore, and as described in subsequent paragraphs, the specific mechanical or electrical configurations described or illustrated are intended to exemplify embodiments of the disclosure. However, alternative mechanical or electrical configurations are possible, which are considered to be within the teachings of the disclosure. Furthermore, unless otherwise indicated, “or” is to be considered inclusive.

The invention is a mat that is easy to position about a tire and capture over-sprayed and runoff fluids employed in wheel care. Preferably, the mat is positioned proximate to a tire such that the mat entirely covers the immediate surface surrounding the footprint of the tire. Once positioned, the mat receives the over spray or run off fluids employed in caring for the wheel or tire.

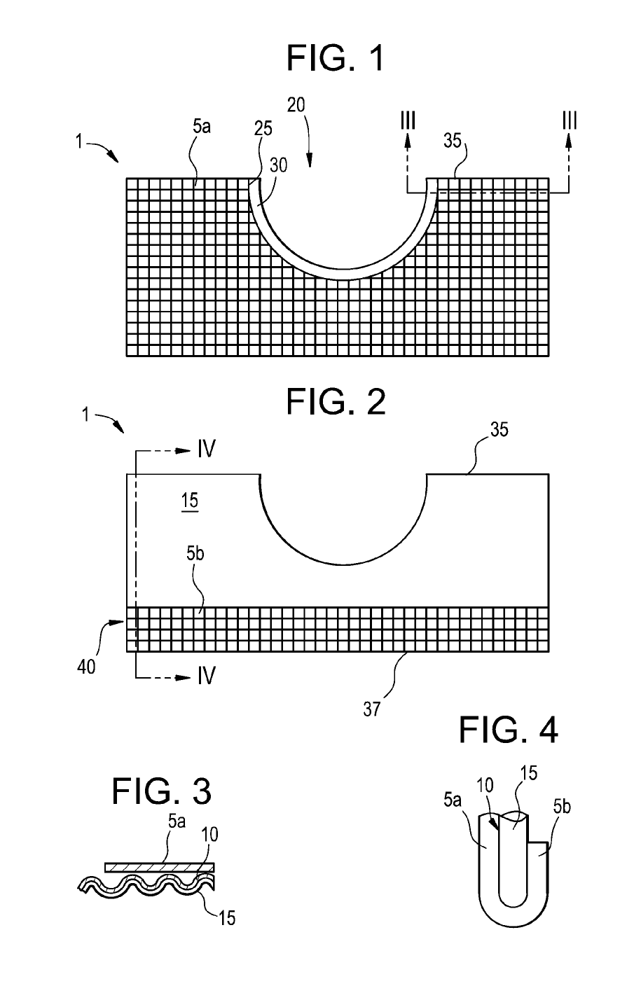

Referring to FIGS. 1 and 3, an embodiment of an apparatus 1 for protecting a surface configured according to principles of the invention includes a substrate 15 and a layer 5 disposed thereon. Substrate 15, preferably, is constructed of a corrugated material, such as cardboard. The corrugations are intended to receive and retain fluid caused by over-spraying or the runoff of solutions employed in maintaining wheels and tires. The corrugations also breakup large volumes of fluid received and prevent the fluid from sloshing about when the invention is removed following wheel maintenance. Other substrate configurations capable of providing these functions are contemplated.

In one embodiment, substrate 15 is constructed of materials that render substrate 15 substantially impervious to fluids, particularly oils or other fluids that could discolor or damage an underlying surface, such as concrete. The paper making arts are replete with many ingredients and techniques for obtaining imperviousness, such as introducing blocking waxes, such as naturally occurs in long-fiber, protein-based cellulose derived from cotton, agave and bast fibers, or absorbent resins or surfactants.

Another embodiment of the invention includes a coating, paint or other impervious layer 10 disposed on substrate 15. Impervious layer 10 cures as an independent layer. Alternatively, layer 10 adsorbs into substrate 15 and cures as a sub-layer within substrate 15 that is impervious as a recognizable sublayer or otherwise renders impervious substrate 15.

Layer 5, preferably, is constructed of a porous or perforated membrane, preferably constructed of rubber, that readily permits fluid received thereon to pass through. Apparatus 1 is constructed so that fluid that passing through layer 5 falls upon and is collected and retained by substrate 15. Preferably, layer 5 permits fluid flow in only one direction, thereby retaining over-sprayed fluid passed to substrate 15.

Preferably, impervious layer 10 is proximate to layer 5 so that fluid passing through layer 5 first encounters impervious layer 10. Uppermost positioning is preferred to prevent fluid adsorption into substrate 15 that, potentially being a corrosive cleaning solution, potentially could chemically degrade substrate 15. The fluid also could simply saturate substrate 15 and diminish its physical integrity like a waterlogged paper towel. Regardless of how the fluid could damage substrate 15, the result could manifest in the form of a rupture in substrate 15 that could allow the fluid to escape onto the surface that apparatus 1 is intended to protect from such fluids.

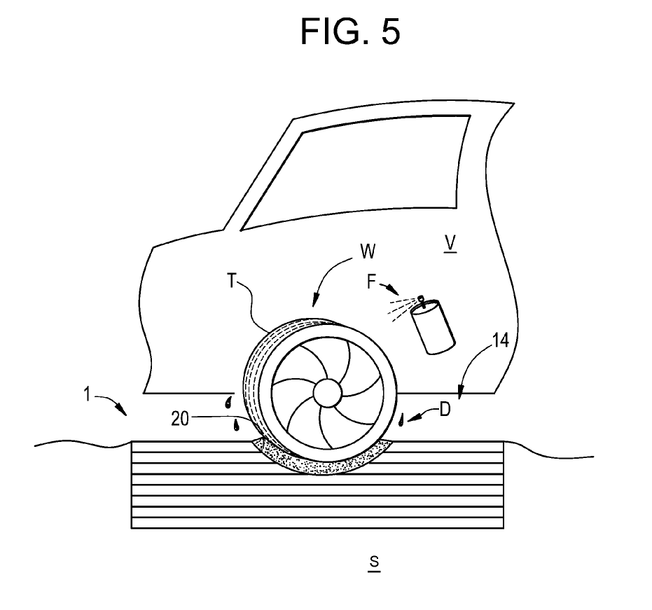

Substrate 15 has a leading edge 35 that has a recess 20. Preferably, recess 20 is configured to complement the footprint of a tire T mounted on a car (not shown) at rest, as shown in FIG. 5. Because vehicles come in a variety of sizes and weights, apparatus 1 is constructed in different sizes to accommodated the smaller footprints of compact car tires through the larger footprints of sport utility vehicles and trucks. The configuration of recess 20 also may be coordinated or tuned according to the specifications of tires on the market. Recess 20 also may define a semicircle or U-shape.

Layer 5 covers nearly all, preferably 75%, of substrate 15. A spacing 30 is defined between an edge 25 of layer 5 and edge 35. Spacing 30 need not be uniform, but rather only configured to provide a thinness to facilitate positioning apparatus 1 as close to, if not wedged under tire T.

As may be understood from FIGS. 1 and 3, corrugations of substrate 15 in FIG. 1 are shown running from top to bottom relative to the page. Preferably, the corrugations run from side to side relative to the page. This orientation of the corrugations will promote retention of fluid collected therein from running out of the ends of corrugations, particularly as apparatus 1 is withdrawn from tire T. When apparatus is withdrawn from tire T, the inertia of the fluid received on substrate 15 may increase the tendency of the fluid to remain in place relative to the tire while apparatus 1 is pulled out from under it, like quickly withdrawing a table cloth and leaving the dishes on the table.

To avert leaving the fluid on the surface around a tire if the mat is withdrawn too quickly, one embodiment of the invention provides for obstructing the terminal ends of the corrugations by crimping or folding substrate 15 along its edges. Other embodiments provide for building up layer 10 or other means suited for accomplishing this purpose.

Referring to FIGS. 2 and 4, apparatus 1 includes an adherent portion 40 for increasing adherence of apparatus 1 to the surface intended to be protected. Preferably, adherent portion 40 covers about 10% of the bottom of substrate 15. Preferably, adherent portion 40 is achieved by folding a portion of layer 5 around a following edge 37 of substrate 15 so that, as shown in FIG. 4, portion 5a of layer 5 is on top of substrate 5 and portion 5b of layer 5 is on the bottom of substrate 15.

Referring to FIG. 5, in practice, apparatus 1 is positioned on the outside of a wheel W of a vehicle V, preferably such that recess 20 closely complements the footprint of the tire T. Vaporized fluid F, such as cleaning solution, is sprayed onto tire T or wheel W. Drips D of the fluid F from wheel W or tire T and/or condensed vaporized fluid F, rather than falling directly on a surface S on which tire T is at rest, falls onto apparatus 1. Drips D first contact layer 5. Fluid F passes through layer 5 and onto substrate 15. Preferably, being coated with impervious layer 10, substrate 15 retains rather than absorbs fluid F, which could thereafter stain surface S. When wheel/tire maintenance is completed, apparatus 1 is removed with the fluid retained therein.

The invention is not limited to the particular embodiment described and depicted herein, rather only to the following claims.

I claim:

1. Apparatus for protecting a surface comprising:
a substrate configured to receive fluid; and
a layer disposed on said substrate configured to pass fluid;
wherein said substrate has a leading edge with a recess having a configuration selected from: complementing a portion of a tire footprint; defining a semicircle, defining a U-shape; and combinations thereof.

2. Apparatus of claim 1, wherein said substrate is fluid impermeable.

3. Apparatus of claim 1, further comprising an impermeable coating or layer interposed between said substrate and said layer.

4. Apparatus of claim 1, wherein said substrate has corrugations.

5. Apparatus of claim 1, wherein said layer is constructed of perforated rubber.

6. Apparatus of claim 1, wherein said layer passes fluid only in one direction.

7. Apparatus of claim 1, wherein said layer and said substrate define a spacing adjacent to said recess where said layer is not disposed on said substrate.

8. Apparatus of claim 1, wherein said substrate has corrugations that are aligned with said leading edge.

9. Apparatus of claim 1, wherein said substrate has a bottom side that is adapted to adhere to the surface.

10. Apparatus of claim 1, wherein said substrate has a top side and a bottom side, said layer being disposed on said top side, wrapping around a following edge of said substrate and extending along said bottom side toward said leading edge.

11. Apparatus of claim 10, wherein at least the portion of said layer on said bottom side is configured to adhere to the surface.
